(19) United States
(12) Patent Application Publication
(10) Pub. No.: US 2026/0047584 A1
(43) Pub. Date: Feb. 19, 2026

(54) TANGZHONG COMPRISING LIQUID DAIRY PRODUCT, BREAD DOUGH COMPRISING SAME AND BREAD MANUFACTURED USING SAME

(71) Applicant: CJ FOODVILLE CORP., Seoul (KR)

(72) Inventor: Minah LEE, Seoul (KR)

(73) Assignee: CJ FOODVILLE CORP., Seoul (KR)

(21) Appl. No.: 19/302,591

(22) Filed: Aug. 18, 2025

(30) Foreign Application Priority Data
Aug. 19, 2024 (KR) 10-2024-0110735
Apr. 3, 2025 (KR) 10-2025-0043736

(51) Int. Cl. A21D 8/02; A21D 2/26; A21D 6/00

(52) U.S. Cl. CPC A21D 8/02; A21D 2/263; A21D 6/001; A21D 6/003

(57) ABSTRACT

The present disclosure relates to a tangzhong comprising a liquid dairy product, a bread dough comprising the tangzhong, and bread prepared using the same. In the present disclosure, by preparing a tangzhong using wheat flour and a liquid dairy product without any addition of water, it is possible to produce a tangzhong that is moister, softer, and has a slower staling rate compared to conventional tangzhong prepared using water. In addition, when bread is prepared using the tangzhong of the present disclosure, the resulting bread exhibits high moisture retention and a slow staling rate, maintains moistness over time, and has excellent flavor, texture, and cross-sectional integrity, with a chewy crumb and an enhanced flavor characteristic of dairy products.

### CROSS-REFERENCE TO RELATED APPLICATIONS

This application claims the priority to Korean Patent Application No. 10-2024-0110735 and 10-2025-0043736 filed on Aug. 19, 2024 and Apr. 3, 2025, respectively, in the Korean Intellectual Property Office, the disclosure of which is incorporated herein by reference.

### BACKGROUND

### Field

The present invention relates to a tangzhong comprising a liquid dairy product, a bread dough comprising same, and bread prepared using same, and more specifically, to a tangzhong prepared by mixing wheat flour and a liquid dairy product, a bread dough comprising same, and bread prepared using same.

### Description of the Related Art

Bread is a product prepared by mixing basic ingredients such as wheat flour, yeast, water, and salt in a kneader to develop gluten, allowing the dough to expand through yeast fermentation, and baking the dough using a pan, and depending on the type, the dough form, fermentation, and baking conditions may vary. Tangzhong is a gel-like mixture prepared by heating wheat flour and water, and it is added to bread dough to enhance the flavor and texture of the bread and to delay staling.

When bread is prepared using tangzhong, it is possible to incorporate more moisture into the dough, resulting in moister bread with a softer and fluffier texture, and bread prepared using tangzhong may exhibit a longer shelf life compared to general bread. Due to these advantages, tangzhong has been used in the preparation of various types of bread, such as red bean bread, streusel bread, and milk bread, and its application has recently expanded to a wider variety of bread products.

For example, Korean Patent No. 10-2224153 discloses a fermented bread containing germinated brown rice and a tangzhong infused with Acanthopanax senticosus, and describes a method for preparing nutritionally functional fermented bread by mixing germinated brown rice powder, pregelatinized starch, yeast, and various plant-based materials. In addition, Korean Patent No. 10-2759391 discloses a method for preparing white rolls using a dough comprising milk and tangzhong, and describes a method for producing white rolls having a soft texture through a combination of various dough fermentation and heating processes.

However, the tangzhong disclosed in the above documents does not include a liquid dairy product itself as a moisture source capable of providing beneficial nutritional components, and there remain limitations in simultaneously achieving structural stability and functional improvement of tangzhong. In particular, there has been no specific disclosure of tangzhong in which the unique flavor and nutritional components of dairy products are actively reflected in the composition to simultaneously improve various quality factors such as texture, moisture retention, and cross-sectional integrity.

Accordingly, the inventors of the present invention have developed a tangzhong based solely on a liquid dairy product as the moisture source, without any addition of water, and have confirmed that, when used in bread preparation, it is possible to produce bread having excellent moisture retention, maintaining moistness over time, with a soft and chewy internal texture and an enhanced flavor characteristic of dairy products, thereby completing the present invention.

### SUMMARY

An object of the present disclosure is to provide a tangzhong capable of improving the flavor, texture, and cross-sectional integrity of bread.

Another object of the present disclosure is to provide a bread dough comprising the tangzhong.

Still another object of the present disclosure is to provide bread prepared using the bread dough.

In order to achieve the above objects, the present disclosure provides a tangzhong comprising a gelatinized mixture obtained by mixing and heating wheat flour and a liquid dairy product.

In the tangzhong of the present disclosure, the amount of the liquid dairy product may be 400 to 1000 parts by weight based on 100 parts by weight of the wheat flour.

In the tangzhong of the present disclosure, the liquid dairy product may comprise milk and fresh cream.

In the tangzhong of the present disclosure, the fresh cream may be animal-derived fresh cream.

In the tangzhong of the present disclosure, the amount of the milk may be 365 to 835 parts by weight based on 100 parts by weight of the wheat flour.

In the tangzhong of the present disclosure, the amount of the fresh cream may be 35 to 165 parts by weight based on 100 parts by weight of the wheat flour.

In the tangzhong of the present disclosure, the weight ratio of the fresh cream to the milk may be 1:2 to 1:10.

In the tangzhong of the present disclosure, the tangzhong may further comprise at least one selected from sugar and a preservative.

The present disclosure also provides a bread dough comprising wheat flour, yeast, and tangzhong, wherein the tangzhong comprises a gelatinized mixture obtained by mixing and heating wheat flour and a liquid dairy product.

In the bread dough of the present disclosure, the amount of the tangzhong may be 23 to 43 parts by weight based on 100 parts by weight of the wheat flour used in the bread dough.

In the bread dough of the present disclosure, the bread dough may further comprise at least one ingredient selected from the group consisting of sugar, salt, powdered milk, milk, improver, butter, shortening, and flavoring agent.

The present disclosure also provides bread prepared using the bread dough.

In the bread of the present disclosure, the bread may be at least one selected from the group consisting of white bread, bagel, brioche, sweet bread, twisted bread, yeast donut, Mont Blanc, butter roll, pizza crust, and cheese stick.

The present disclosure further provides a method for preparing a tangzhong, comprising the steps of (i) preparing a mixture by adding wheat flour to a liquid dairy product; (ii) preparing a gelatinized dough by first stirring and heating the mixture; and (iii) second stirring and cooling the gelatinized dough.

The method of the present disclosure may further comprise the step of aging the prepared tangzhong.

In the method of the present disclosure, the heating temperature in step (ii) may be 60 to 100° C.

In the method of the present disclosure, the stirring in step (ii) may be performed at a speed of 200 to 1,500 rpm for 10 to 60 minutes.

In the method of the present disclosure, the cooling temperature in step (iii) may be 50 to 80° C.

In the method of the present disclosure, the stirring speed in step (iii) may be 100 to 1,000 rpm.

In the method of the present disclosure, the aging of the tangzhong may be performed at −5 to 15° C. for 12 to 36 hours.

In the present disclosure, by preparing a tangzhong using wheat flour and a liquid dairy product without any addition of water, it is possible to produce a tangzhong that is moister, softer, and has a slower staling rate compared to conventional tangzhong prepared using water. In addition, when bread is prepared using the tangzhong of the present disclosure, it exhibits high moisture retention and a slow staling rate, maintains moistness over time, and provides bread having excellent flavor, texture, and cross-sectional integrity, with a chewy crumb and an enhanced flavor characteristic of dairy products.

### BRIEF DESCRIPTION OF THE DRAWINGS

FIG. 1a shows a photograph of the tangzhong preparation process according to one embodiment of the present disclosure.

FIG. 1b shows a photograph of the tangzhong prepared according to one embodiment of the present disclosure.

FIG. 2a shows a photograph of the bread dough prepared according to one embodiment of the present disclosure.

FIG. 2b shows a photograph of the bread prepared according to one embodiment of the present disclosure.

### DETAILED DESCRIPTION OF THE PREFERRED EMBODIMENT

Hereinafter, specific embodiments of the present disclosure will be described in more detail. Unless otherwise defined, all technical and scientific terms used in the present specification have the same meaning as commonly understood by those skilled in the art to which the present disclosure pertains. In general, the nomenclature used in the present specification is well known and commonly used in the relevant technical field.

The present disclosure relates to a tangzhong comprising wheat flour and a liquid dairy product. In the present disclosure, by preparing a tangzhong using a liquid dairy product, specifically milk, fresh cream, and the like, without any addition of water, it is possible to reduce the staling rate of the tangzhong and improve its moistness and softness. In addition, using the tangzhong, it is possible to prepare bread that exhibits high moisture retention, maintains moistness over time, has a chewy crumb, and provides excellent flavor, texture, and cross-sectional integrity with an enhanced flavor characteristic of dairy products.

The tangzhong of the present disclosure may comprise wheat flour and a liquid dairy product, and more specifically, may comprise a gelatinized mixture obtained by mixing and heating wheat flour and a liquid dairy product.

In the present disclosure, the wheat flour used in the preparation of the tangzhong may comprise strong flour or medium flour, and preferably may comprise strong flour.

In addition, in the present disclosure, the liquid dairy product may comprise at least one selected from milk, fresh cream, and skimmed concentrated milk, and preferably may comprise milk and fresh cream.

Unlike general tangzhong prepared by mixing wheat flour and water, in the present disclosure, the tangzhong is prepared by mixing wheat flour with milk, and by adding a small amount of fresh cream to the milk, the nutty taste and rich flavor characteristic of dairy products can be enhanced.

Further, the tangzhong of the present disclosure has a slower staling rate (i.e., hardening rate) compared to general tangzhong using water, and after cooling, it exhibits a texture that is moist and soft like a jelly rather than resembling dough, while forming into a single cohesive mass.

In the tangzhong of the present disclosure, the liquid dairy product may be comprised in an amount of 400 to 1000 parts by weight, preferably 500 to 900 parts by weight, more preferably 600 to 800 parts by weight, based on 100 parts by weight of the wheat flour. When the amount of the liquid dairy product is within the above range, the prepared tangzhong may have appropriate viscosity and elasticity, and may exhibit a moist texture and the characteristic flavor of dairy products.

When milk is used as the liquid dairy product, the amount of milk in the tangzhong of the present disclosure may be 365 to 835 parts by weight, preferably 445 to 755 parts by weight, more preferably 525 to 675 parts by weight, based on 100 parts by weight of wheat flour.

In addition, when fresh cream is added as the liquid dairy product, the amount of fresh cream in the tangzhong of the present disclosure may be 35 to 165 parts by weight, preferably 55 to 145 parts by weight, more preferably 75 to 125 parts by weight, based on 100 parts by weight of wheat flour.

In the present disclosure, the fresh cream may comprise at least one selected from animal-derived fresh cream and plant-derived fresh cream, and preferably may be animal-derived fresh cream. The animal-derived fresh cream refers to fresh cream made from fat separated from milk, while the plant-derived fresh cream refers to fresh cream made from vegetable fats such as palm oil, aza oil, and edible oils.

In the present disclosure, fresh cream is mixed with milk as tangzhong ingredients, and by appropriately adjusting the ratio of the milk and fresh cream, the resulting tangzhong can exhibit viscosity and elasticity suitable for dough preparation. Furthermore, the bread prepared using the tangzhong may have a flavor in which the rich and smooth taste characteristic of dairy products is perceived, while greasy notes are suppressed and the fresh taste of milk is maintained.

From this perspective, the liquid dairy product comprised in the tangzhong of the present disclosure may comprise milk and fresh cream, and the weight ratio of the fresh cream to the milk may be 1:2 to 1:10, preferably 1:3 to 1:8, more preferably 1:5 to 1:7.

In one embodiment of the present disclosure, as a result of comparing the physical properties of tangzhong prepared by adjusting the weight ratio of milk and fresh cream, it was confirmed that when milk and fresh cream are mixed at a specific weight ratio, the prepared tangzhong exhibits viscosity and elasticity suitable for incorporation into dough without being too runny or too thick, and the bread prepared using the tangzhong has a rich, soft taste and fresh flavor characteristic of dairy products.

The tangzhong of the present disclosure may further comprise sugar, and in the tangzhong of the present disclosure, the sugar may be comprised in an amount of 0.5 to 10 parts by weight, preferably 1 to 5 parts by weight, more preferably 1 to 3 parts by weight, based on 100 parts by weight of wheat flour.

In addition, the tangzhong of the present disclosure may further comprise at least one preservative selected from the group consisting of ε-polylysine, sodium propionate, calcium propionate, and potassium propionate, and preferably may be ε-polylysine. In the tangzhong of the present disclosure, the preservative may be comprised in an amount of 0.05 to 1 part by weight, preferably 0.1 to 0.5 parts by weight, more preferably 0.1 to 0.3 parts by weight, based on 100 parts by weight of wheat flour.

The tangzhong of the present disclosure may be prepared by mixing and heating wheat flour and a liquid dairy product.

Specifically, the tangzhong of the present disclosure is prepared by performing the following steps: preparing a mixture by adding wheat flour to a liquid dairy product; preparing a gelatinized dough by first stirring and heating the mixture; and second stirring and cooling the gelatinized dough.

First, a mixture is formed by adding wheat flour to a liquid dairy product. At this time, sugar, a preservative, or both may be added to the liquid dairy product together with the wheat flour.

Thereafter, the step of preparing a gelatinized dough by first stirring and heating the mixture is performed.

The first stirring may be performed at 200 to 1,500 rpm, preferably 300 to 1,000 rpm, more preferably 700 to 900 rpm, for 10 to 60 minutes, preferably 20 to 40 minutes.

Heating of the mixture may be performed in conjunction with the first stirring, and specifically, the mixture may be heated to 60 to 100° C., preferably 70 to 90° C., more preferably 75 to 85° C. to prepare the gelatinized dough. If the heating temperature is too high, the viscosity of the tangzhong becomes excessively strong, resulting in a sticky dough and an excessively high dough temperature, and the color may turn yellow due to caramelization. On the other hand, if the heating temperature is too low, the viscosity becomes insufficient, eliminating the bouncy texture and making it difficult to achieve a moist and chewy mouthfeel.

Next, the tangzhong may be prepared by performing the step of second stirring and cooling the gelatinized dough.

The second stirring may be performed at 100 to 1,000 rpm, preferably 200 to 700 rpm, more preferably 400 to 600 rpm.

Cooling of the gelatinized dough may be performed together with the second stirring, and the cooling temperature may be 50 to 80° C., preferably 60 to 70° C., more preferably 65 to 75° C.

Thereafter, a step of aging the prepared tangzhong at low temperature may be performed, and specifically, the tangzhong may be aged by storing it at −5 to 15° C., preferably 0 to 10° C., for 12 to 36 hours, preferably 18 to 30 hours.

It is preferable that the tangzhong thus prepared be used within 7 days, more specifically within 6 days, from the date of preparation.

By being prepared without water and using a liquid dairy product, the tangzhong of the present disclosure exhibits enhanced nutty taste and rich flavor characteristic of the liquid dairy product, and compared to tangzhong made with water, it has a slower staling rate and exhibits a moist and soft formulation upon cooling, while forming into a single cohesive mass. Accordingly, the tangzhong of the present disclosure may be usefully applied in the preparation of various types of bread, for example, white bread.

The present disclosure may also provide a bread dough comprising the tangzhong, and bread prepared using the same. In the present disclosure, the bread may be at least one selected from the group consisting of white bread, bagel, brioche, sweet bread, twisted bread, yeast donut, Mont Blanc, butter roll, pizza crust, and cheese stick, and preferably may be white bread.

Specifically, in the present disclosure, a bread dough may be prepared by mixing water with dough ingredients comprising wheat flour, yeast, and the tangzhong, and bread may be prepared by baking the dough.

The wheat flour used in the bread dough of the present disclosure may be at least one baking flour selected from the group consisting of strong flour, medium flour, whole wheat flour, rye flour, and bran flour, and preferably may be strong flour.

In the bread dough of the present disclosure, the tangzhong may be comprised in an amount of 23 to 43 parts by weight, preferably 26 to 40 parts by weight, more preferably 30 to 36 parts by weight, based on 100 parts by weight of the wheat flour used in the bread dough. If the amount of tangzhong in the bread dough is too high, problems may arise such as reduced bread volume and excessive chewiness causing toughness in the crust due to the tangzhong. By adjusting the tangzhong amount to optimize the balance of the dough, bread, and more specifically white bread, having both excellent texture and volume may be produced.

In one embodiment of the present disclosure, as a result of comparing the physical properties of bread prepared by adjusting the amount of tangzhong, it was confirmed that when the tangzhong is comprised in a specific amount, the ingredients blend well without stickiness during dough division, and the resulting bread exhibits an appetizing appearance, a chewy yet not tough texture, and the flavor and nutty taste of dairy products.

In the bread dough of the present disclosure, water may be comprised in an amount of 22 to 42 parts by weight, preferably 25 to 39 parts by weight, more preferably 29 to 35 parts by weight, based on 100 parts by weight of the wheat flour used in the bread dough.

The yeast serves to promote fermentation and provide volume to the bread, and in consideration of the flavor and fermentation properties, may be comprised in an amount of 1 to 5 parts by weight, preferably 2 to 3 parts by weight, based on 100 parts by weight of the wheat flour used in the bread dough.

In a preferred embodiment of the present disclosure, the bread dough may be dough for white bread, and may further comprise at least one ingredient selected from the group consisting of sugar, salt, powdered milk, milk, improver, butter, shortening, and flavoring agent.

In the bread dough of the present disclosure, sugar is an ingredient added to facilitate fermentation by decomposing sugar content in the dough, and may be comprised in an amount of 10 to 15 parts by weight, preferably 11 to 14 parts by weight, based on 100 parts by weight of the wheat flour used in the bread dough.

Meanwhile, the salt not only imparts flavor to the bread, but also serves to strengthen the gluten structure to improve the bread volume and to regulate the fermentation rate. The salt may be comprised in an amount of 0.5 to 5 parts by weight, preferably 1 to 3 parts by weight, based on 100 parts by weight of the wheat flour used in the bread dough.

The powdered milk is an ingredient that adds flavor to the bread and helps retain moisture and promote browning, and may be comprised in an amount of 1 to 5 parts by weight, preferably 2 to 4 parts by weight, based on 100 parts by weight of the wheat flour used in the bread dough.

In addition, the milk is an ingredient that enhances the flavor and softness of the bread and improves moisture retention and browning, thereby improving the texture and appearance of the product. The milk may be comprised in an amount of 13 to 23 parts by weight, preferably 15 to 21 parts by weight, based on 100 parts by weight of the wheat flour used in the bread dough.

The improver is an ingredient that enhances the elasticity and gas retention capacity of the dough to improve the volume and texture of the bread, and may be comprised in an amount of 0.1 to 2 parts by weight, preferably 0.2 to 1 part by weight, based on 100 parts by weight of the wheat flour used in the bread dough.

Meanwhile, the butter is an ingredient that softens the texture of the bread and enhances its flavor, and may be comprised in an amount of 1 to 7 parts by weight, preferably 2 to 6 parts by weight, based on 100 parts by weight of the wheat flour used in the bread dough.

The shortening is an ingredient that imparts smoothness and a crispy texture to the dough. The shortening may be comprised in an amount of 1 to 7 parts by weight, preferably 2 to 6 parts by weight, based on 100 parts by weight of the wheat flour used in the bread dough.

In addition, the flavoring agent is an ingredient that enhances the flavor of the bread to improve consumer preference, and serves to supplement or emphasize the original taste and aroma of the bread. The flavoring agent may be comprised in an amount of 0.01 to 1 part by weight, preferably 0.02 to 0.08 parts by weight, based on 100 parts by weight of the wheat flour used in the bread dough. In the present disclosure, the flavoring agent may be a milk flavoring agent.

In the present disclosure, the bread dough may be formed by mixing the above bread dough ingredients, and the core temperature during preparation of the bread dough may be 12 to 24° C., preferably 15 to 21° C., more preferably 16 to 20° C.

In the present disclosure, the bread dough prepared by mixing the above bread dough ingredients may be divided and shaped, then rapidly frozen for storage. The rapid freezing temperature may be −40 to −30° C., preferably −37 to −33° C., and the core temperature of the dough after freezing may be −12 to −2° C., preferably −10 to −4° C. The storage temperature may be −22 to −14° C., preferably −20 to −16° C.

During bread preparation, the frozen bread dough may be thawed and baked to prepare the bread. Prior to baking, the dough may be subjected to shaping, panning, and fermentation.

### EXAMPLES

Hereinafter, the present disclosure will be described in more detail with reference to the following Examples. However, these Examples merely illustrate certain experimental methods and compositions to aid understanding of the present disclosure and are not intended to limit the scope of the present disclosure.

### Preparation Example 1: Preparation of Tangzhong Comprising Liquid Dairy Product

Tangzhong was prepared by mixing 600 parts by weight of milk, 100 parts by weight of animal-based fresh cream, 2 parts by weight of white sugar, and 0.2 parts by weight of ε-polylysine with respect to 100 parts by weight of strong flour.

First, a mixture was prepared by adding powder-form strong flour, sugar, and ε-polylysine to liquid-form milk and fresh cream in the above amounts.

Subsequently, the mixture was subjected to first stirring at 800 rpm and heated for 30 minutes until the temperature of the mixture reached 80° C. Then, the heated mixture was subjected to second stirring at 500 rpm and cooled until the temperature of the mixture reached 70° C., thereby preparing the tangzhong.

The prepared tangzhong was divided into 10 kg portions, packaged, and stored in a refrigerated warehouse at 0 to 10° C. for 24 hours to allow aging of the tangzhong.

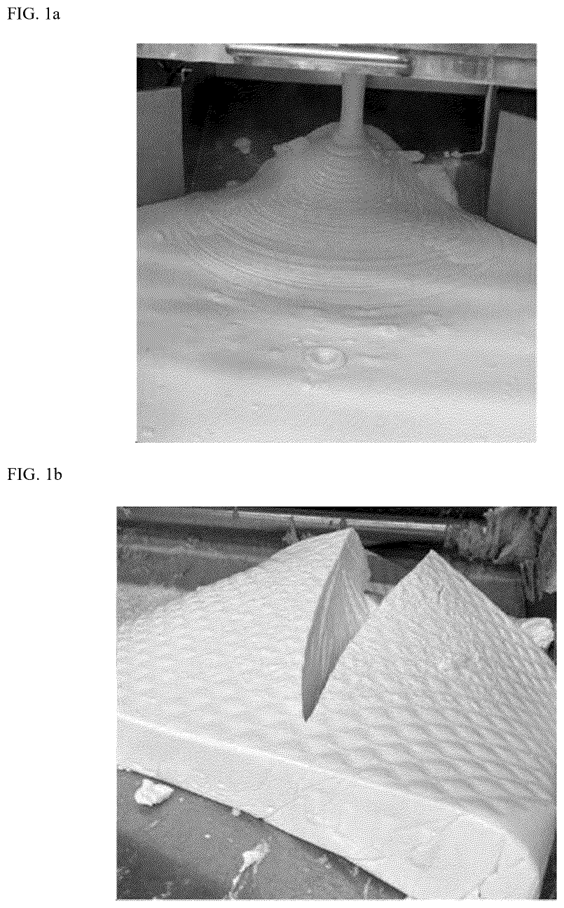

As part of the tangzhong preparation process, the discharge of tangzhong from the machine is shown in FIG. 1a, and a photograph of the prepared tangzhong is shown in FIG. 1b.

### Preparation Example 2: Preparation of Bread Using Tangzhong Comprising Liquid Dairy Product

White bread was prepared using the tangzhong prepared in Preparation Example 1. The ingredients were weighed and mixed according to the weight ratios shown in Table 1 to prepare the bread dough. The core temperature of the ingredients was adjusted to approximately 15 to 21° C. during weighing.

TABLE 1

| Ingredients | Weight ratio |
|---|---|
| strong flour | 96.00 |
| white sugar | 12.00 |
| salt | 1.90 |
| high-sugar frozen dough yeast | 2.40 |
| powdered milk | 3.00 |
| improver | 0.50 |
| milk | 17.00 |
| water | 31.00 |
| tangzhong of Preparation Example 1 | 32.00 |
| processed butter | 4.00 |
| shortening | 4.00 |
| milk flavoring agent | 0.05 |

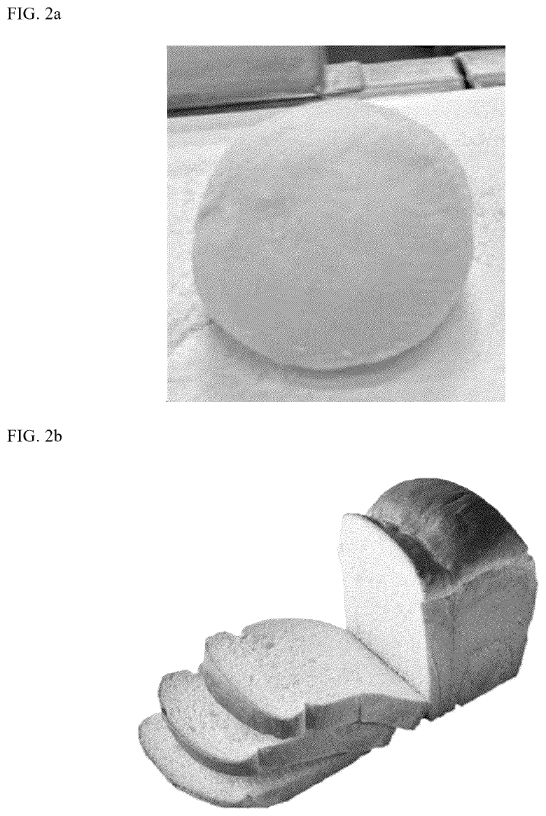

The bread dough was mixed while maintaining a dough temperature of 22.0±2.0° C., divided into approximately 260 g portions, and shaped into forms of approximately Φ90 mm×55 mm. The shaped dough was then rapidly frozen at −35° C. for 30 minutes until the core temperature reached −7±3° C., followed by metal detection and packaging, and stored in a frozen warehouse at −18° C. or below. A photograph of the prepared dough is shown in FIG. 2a.

To prepare white bread from the frozen dough, the dough was thawed until the core temperature reached 20° C., then fermented at 33° C. and 80% humidity for 60 minutes. Thereafter, baking was performed for 35 minutes in an oven set to 170° C. for the top and 210° C. for the bottom. A photograph of the resulting white bread product is shown in FIG. 2b.

The prepared white bread exhibited a moist, chewy yet easy-to-tear texture, a rich and smooth flavor characteristic of dairy products, and a flavor profile in which the fresh taste of milk was retained. Through this, it was confirmed that the use of the tangzhong of the present disclosure allows the production of bread having excellent consumer preference in both flavor and texture.

### Experimental Example 1: Comparison of Bread Properties According to the Weight Ratio of Milk to Fresh Cream

Tangzhong was prepared in the same manner as in Preparation Example 1, except that the weight ratio of milk to animal-derived fresh cream was varied to 7:0, 6:1, and 4:3, respectively. Three white bread products were then prepared using the tangzhong according to the same method as in Preparation Example 2.

When the tangzhong was prepared at a weight ratio of 6:1 (milk:fresh cream), the tangzhong exhibited neither excessive thinness nor stiffness, showing viscosity and elasticity suitable for incorporation into dough. The white bread prepared using the tangzhong exhibited the savory and soft characteristics unique to dairy products, without any greasy taste, and showed a flavor that retained the freshness of milk.

In contrast, the tangzhong prepared without using fresh cream (milk:fresh cream=7:0) showed a sticky and undesirable consistency unsuitable for incorporation into the dough, and required an extended heating time to obtain suitable physical properties. Furthermore, the resulting white bread had a relatively bland taste and lacked the rich and smooth flavor typical of dairy products.

Meanwhile, when the tangzhong was prepared at a weight ratio of 4:3 (milk:fresh cream), adhesion to the bottom or wall of the vessel occurred, and after cooling, the tangzhong became too firm, rendering it unsuitable for incorporation into the dough. Additionally, the white bread prepared using the tangzhong did not exhibit the light and fresh flavor of milk due to the high proportion of fresh cream and instead presented a greasy and overly rich taste.

These results confirmed that by appropriately adjusting the weight ratio of milk and fresh cream in the tangzhong, it is possible to produce bread having excellent flavor, crumb structure, and texture.

### Experimental Example 2: Comparison of Bread Properties According to the Input Ratio of Tangzhong

White bread was prepared in the same manner as in Preparation Example 2, except that the input weight ratio of tangzhong was adjusted to 14 and 42, respectively. The resulting bread was compared with the bread prepared in Preparation Example 2.

First, the bread of Preparation Example 2 was produced without stickiness during ingredient blending and dough division, making the dough easy to handle. However, when the tangzhong input ratio was 42, the dough became extremely sticky and slack, resulting in an increase in dough temperature and a problem of weight deviation during division.

Next, a comparison of the external appearance of the prepared dough and bread revealed that the bread of Preparation Example 2 could be produced under baking conditions similar to those of general white bread without any deformation of the outer shape. In contrast, when the tangzhong input ratio was 42, the sides of the white bread became indented after baking. Extending the baking time to avoid this resulted in excessive moisture loss, over-browning of the upper crust, and insufficient oven spring, leading to reduced bread volume.

Furthermore, a comparison of the texture and flavor of the prepared dough and bread showed that the white bread of Preparation Example 2 exhibited a chewy texture without toughness, along with an appropriate dairy flavor and nutty taste.

In contrast, when the tangzhong input ratio was 14, the chewiness was reduced and the dairy flavor was barely perceptible. When the tangzhong input ratio was 42, the excessive amount of tangzhong resulted in a tough texture, and the extended baking time caused the crust to become tough and increased the risk of burnt flavor development.

These results confirmed that by appropriately adjusting the amount of tangzhong in white bread preparation, it is possible to produce white bread having excellent appearance, texture, and flavor.

From the above description, those skilled in the art will understand that the present disclosure may be implemented in other specific forms without departing from the technical spirit or essential characteristics thereof. Accordingly, the embodiments described above are to be understood in all respects as illustrative and not restrictive.

What is claimed is:

1. A tangzhong comprising a gelatinized mixture obtained by mixing and heating wheat flour and a liquid dairy product.

2. The tangzhong of claim 1,
wherein an amount of the liquid dairy product is 400 to 1000 parts by weight based on 100 parts by weight of the wheat flour.

3. The tangzhong of claim 1,
wherein the liquid dairy product comprises milk and fresh cream.

4. The tangzhong of claim 3,
wherein the fresh cream is animal-derived fresh cream.

5. The tangzhong of claim 3,
wherein an amount of the milk is 365 to 835 parts by weight based on 100 parts by weight of the wheat flour.

6. The tangzhong of claim 3,
wherein an amount of the fresh cream is 35 to 165 parts by weight based on 100 parts by weight of the wheat flour.

7. The tangzhong of claim 3,
wherein a weight ratio of the fresh cream to the milk is 1:2 to 1:10.

8. The tangzhong of claim 3,
wherein the tangzhong further comprises at least one selected from sugar and a preservative.

9. A bread dough comprising wheat flour, yeast, and a tangzhong,
wherein the tangzhong comprises a gelatinized mixture obtained by mixing and heating wheat flour and a liquid dairy product.

10. The bread dough of claim 9,
wherein an amount of the tangzhong is 23 to 43 parts by weight based on 100 parts by weight of the wheat flour used in the bread dough.

11. The bread dough of claim 9,
wherein the bread dough further comprises at least one ingredient selected from the group consisting of sugar, salt, powdered milk, milk, improver, butter, shortening, and flavoring agent.

12. A bread prepared using the bread dough of claim 9.

13. The bread of claim 12,
wherein the bread is at least one selected from the group consisting of white bread, bagel, brioche, sweet bread, twisted bread, yeast donut, Mont Blanc, butter roll, pizza crust, and cheese stick.

14. A method for preparing a tangzhong, comprising the steps of:
(i) preparing a mixture by adding wheat flour to a liquid dairy product;
(ii) preparing a gelatinized dough by first stirring and heating the mixture; and
(iii) second stirring and cooling the gelatinized dough.

15. The method of claim 14,
further comprising the step of aging the prepared tangzhong.

16. The method of claim 14,
wherein a heating temperature in step (ii) is 60 to 100° C.

17. The method of claim 14,
wherein stirring in step (ii) is performed at a speed of 200 to 1,500 rpm for 10 to 60 minutes.

18. The method of claim 14,
wherein a cooling temperature in step (iii) is 50 to 80° C.

19. The method of claim 14,
wherein a stirring speed in step (iii) is 100 to 1,000 rpm.

20. The method of claim 15,
wherein the aging of the tangzhong is performed at −5 to 15° C. for 12 to 36 hours.
